(19) United States
(12) Patent Application Publication
(10) Pub. No.: US 2024/0245073 A1
(43) Pub. Date: Jul. 25, 2024

(54) WATER-SOLUBLE PLANT PROTEIN, METHOD FOR PRODUCING SAME, AND USE THEREOF

(71) Applicant: EMSLAND STÄRKE GMBH, Emlichheim (DE)

(72) Inventors: Jantje BOUWERS, Emlichheim (DE); Martina BOUKAMP, Emlichheim (DE); Karl-Ludwig WOLL, Emlichheim (DE); Nadja VENNEGERTS, Emlichheim (DE)

(21) Appl. No.: 18/289,888

(22) PCT Filed: May 11, 2022
(86) PCT No.: PCT/DE2022/100356

§ 371 Date: Nov. 7, 2023

(30) Foreign Application Priority Data
May 11, 2021 (DE) 20 2021 102 596.4

(51) Int. Cl. A23J 1/14; A23J 1/00; A23J 3/16; A23J 3/34

(52) U.S. Cl. CPC A23J 1/14; A23J 1/006; A23J 3/16; A23J 3/346

(57) ABSTRACT

A low-molecular water-soluble plant protein which has a molecular weight of <75 kDa and >5 kDa and is made of protein-containing plant parts, has a) a protein content of 60-95 wt. %; b) a moisture content of 4-8 wt. %; c) a foam volume of 1700-3100 ml; d) a foam stability of 80-100%; and e) a product solubility in water of 100% (pH 7-pH 9)—and also a method for producing same from plant parts and water; the plant pulp being mechanically separated into starch and fibers and an aqueous solution (juice); thermally coagulating the juice and then mechanically separating the coagulated protein, then carrying out a phytate reduction process, separating phytates; and carrying out an ultrafiltration process on the filtrate of the phytate reduction or the nanofiltration retentate.

The invention relates to a water-soluble plant protein with a molecular weight (according to SDS-page primary structure) between <75 kDa and >5 kDa, preferably <70 kDa and >7 kDa and particularly preferably <68 kDa and >10 kDa; method for producing the same and use thereof. In the context of this application, the proteins are referred to in particular as the protein mixtures comprising a wide variety of individual proteins.

### TECHNICAL FIELD

The extraction of the plant proteins, here exemplified by the pea proteins, has so far been carried out using the relatively simple processes. The pea proteins are isolated from the pea fruit water, wherein the heat treatment denatures the proteins that are soluble in water, drastically reducing their functionality and solubility. The soluble proteins in the pea fruit water are produced as a by-product of the plant protein production—e.g. soy, oat, lupin and pea protein production—e.g. for animal feed. The side stream—i.e, the thermally non-coagulated smaller proteins with a molecular weight of <75 kDa, salts, sugars, peptides, etc.—is currently concentrated with a high energy input and sold as animal feed, although it still contains valuable ingredients with higher added value.

The thermally coagulated proteins of higher molecular weight have a large loss of functionality with respect to water solubility and emulsion formation—i.e. they no longer dissolve or dissolve poorly in water, bind less water and their ability to form foams is reduced. Smaller proteins have been shown to be less sensitive to temperature.

To achieve the protein functionalities required today for the applications in the food production (e.g. 100% solubility, high emulsifiability, foaming capacity and foam stability), special proteins are needed to prevent the previous extensive thermal denaturation and thus loss of functionality—i.e. also the lack of water solubility—of proteins.

### STATE OF THE ART

To date, no highly functional plant protein that is completely water-soluble and has a molecular weight <75 kDa, such as pea protein, is available on the market.

The technical processing of the pea fruit water is described in the literature. For example, WO2008049385A1 and the printed materials cited in their search report already indicated that the membrane technologies were suitable for the pea protein recovery and fractionation, but at that time they were too costly for the industrial production. At the time, however, the membrane technology was still underdeveloped and considered an expensive separation method. This has now changed, as can be seen from the article “Pilot scale recovery of proteins from a pea whey discharge by ultrafiltration” (Lei (Leigh) Gao, Khai D. Nguyen and Alphonsus C. Utioh, Food Science and technology, vol 34, pp. 149-158, 2001), which deals with the recovery of pea protein by centrifugation with subsequent ultrafiltration. Another method for obtaining the legume proteins, in particular from the water-soluble fraction, is described in U.S. Pat. No. 4,766,204.

As the plant-based proteins become increasingly important in our daily diets, they are becoming more and more important. Above all, the pea proteins, on the basis of which the invention is explained below, are becoming increasingly important, since the demand for GMO-free and allergen-free products has risen worldwide and the peas are relatively unproblematic to grow. In addition, the pea proteins offer important nutritional, functional and processing advantages.

However, the production method can also be used for other highly functional plant proteins, especially those from legumes, and is by no means limited to peas. In the following, the proteins are referred to in particular as the protein mixtures comprising a wide variety of individual proteins.

### OBJECT OF THE INVENTION

It is an object of the invention to improve the functionality of the protein fractions with a molecular weight <75 kDa of the water-soluble high-quality proteins present in the plant fruit water, especially those from peas.

### Achieving the Object

The object is achieved by a plant protein with the features of claim 1 and a method for producing the same and use thereof. The advantageous developments result from the dependent claims.

According to the invention, a low molecular weight water-soluble plant protein which has a molecular weight of <75 kDa and >5 kDa, preferably <70 kDa and >7 kDa and particularly preferably <68 kDa and >10 kDa and is produced from the protein-containing plant parts is obtained, which comprises:
a) Protein content of 60-95 wt. %
b) Moisture content of 4-8%
c) Foam volume of 1700-3100 ml
d) Foam stability of 80-100%
e) Product solubility of 100% (pH 7-pH 9),

The invention further relates to a method for producing this protein mixture, which is a low molecular weight pea protein fraction that is produced using the following method steps:
a) preparing a pea pulp from peas and water, mechanically separating the pea pulp into the insoluble starch and fibers, and an aqueous solution containing the water-soluble proteins, peptides, sugars, salts, and amino acids (pea fruit water);
b) thermally coagulating the pea fruit water at 64-70° C. followed by the mechanical separation of the coagulated denatured pea proteins with a molecular weight >75 kDa;
c) carrying out a phytate reduction by the precipitation of the phytate compounds, adsorption on phytate adsorbers or enzymatic degradation;
d) centrifuging or filtrating to separate the precipitated phytates to obtain a phytate-reduced water-soluble low-molecular-weight protein fraction;
e) optionally carrying out a nanofiltration process of the centrifuge supernatant with a membrane of a cut-off of 150-300 Da, preferably about 180-220 Da, to obtain a protein-rich nanofiltration retentate and a salt-containing permeate;
f) carrying out an ultrafiltration process of the nanofiltration retentate using plastic ultrafiltration membranes with a cut-off of 5-50 kDa preferably 5-30 kDa and particularly preferably 10 kDa or a pore size of 0.09-0.14 micrometer in the case of a ceramic membrane, producing a more protein-rich ultrafiltration retentate;
g) carrying out a diafiltration process on the ultrafiltration retentate using water;
h) optionally pasteurizing the ultrafiltration retentate and
i) optionally drying the ultrafiltration retentate.

The ultrafiltration permeate can be subjected to downstream reverse osmosis as a source of galactooligosaccharides (GOS), sugars, and amino acids, and the purified water in the reverse osmosis permeate can be reused as process water or service water or disposed of.

It is favorable for the function of the low molecular weight pea protein according to the invention that the ultrafiltration retentate is washed by diafiltration with tap water, process water, service water or deionized water until the conductivity of the retentate solution is reduced by 20-80%, preferably 50-75% and particularly preferably by 60-73%, because this removes the unfavorable flavors and accompanying substances that hinder the emulsifying capacity.

The protein according to the invention is isolated from the starch-containing plants or parts thereof selected from root and tuber plants; legume seeds selected from beans, peas, chickpeas, lentils, soybeans; tree fruits; perennials and herbaceous fruits; sweet grasses and their fruits; and algae. The low molecular weight protein is suitable as a component of food or food additives, as a dietary food or food additive for human or animal consumption, supporting the formation of emulsions.

The pea as the starting material is a water-soluble plant protein with a molecular weight between <75 kDa and >5 kDa of high functionality and purity. By processing the pea fruit water according to the invention, the raw material pea is used more efficiently and especially the small proteins with a molecular weight between <75 kDa and >5 kDa are provided without the foam and emulsification behavior disturbing or even antinutritive components.

The foaming capacity of the plant proteins is well known, for example, from beer. However, it is also known that the salts and other ionic components reduce the foaming behavior of the proteins. However, it is desirable to be able to produce stable vegetable foams—e.g. as a substitute for milk foam or egg white foam. The vegetable foamable proteins also have the advantage of being more durable than those of animal origin, such as egg white, and are therefore of particular interest for dry blends of ready-to-eat foods (vegetable egg white substitutes; vegetal foamable milk substitutes, addition to beers that are not brewed according to purity regulations, etc.). Especially for allergy sufferers, but also for vegans, they are in high demand. Furthermore, they are well suited as emulsifiers—also as substitutes for animal proteins and as foaming agents and emulsifiers that can be processed between 5° C. and 65° C. and stored at room temperature for at least 1 year.

### Preparation of the Pea Proteins According to the Invention

The main components obtained from the pea are starch, fiber and protein. For this purpose, the dried or fresh peas are crushed and the pea flour or pea porridge is mixed with water (tap water or deionized water). The mash is separated into the water-insoluble starch-fiber fraction and protein-rich fruit water in a known manner using mechanical liquid/solid separators, e.g. decanters (see e.g. WO2008049385A1). The protein-containing liquid from the mechanical liquid/solid separator is heated to a temperature between 64° C. and 70° C. to flocculate the temperature-sensitive larger proteins by the thermal coagulation. The flocculated, heat-denatured proteins are separated by means of another liquid/solid separation device, e.g., another decanter, yielding an aqueous solution of low-molecular-weight proteins, amino acids, sugars, and small peptides, hereinafter referred to as the low-molecular-weight protein solution. These steps are known, for example, from WO2008049385A1.

In the following, the further processing of the aqueous low molecular weight protein solution according to the invention will be explained in more detail using decanters as mechanical separation devices, to which, however, the separation devices are by no means limited.

The water-soluble proteins, some water-insoluble suspended light components, such as various colloids and small proteins, peptides, sugars, nucleotides, and salts, remain in the aqueous low-molecular-weight protein solution (e.g., from the decanter overflow). This fraction is so far unused as a source of protein for a special protein fraction and used in livestock feed. This aqueous low molecular weight protein solution also still has antinutritive protein components, e.g. PAb1, but also undesirable sugars and GOS. It can be lathered up, but the quality of the foam could be improved. The emulsifiability of such protein mixtures and the taste could also be improved.

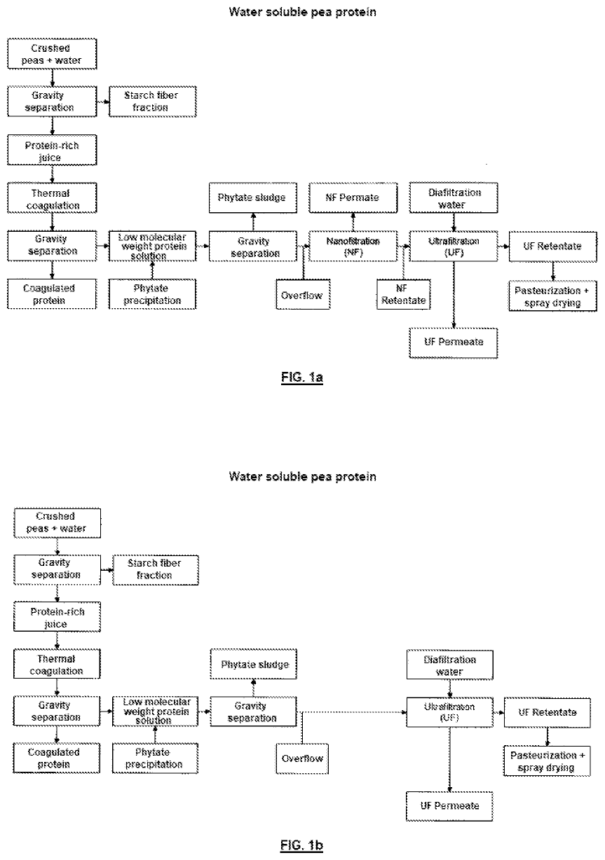

To obtain a functional water-soluble pea protein using membrane technology, these undissolved components can be separated by means of a further mechanical separation process, e.g. centrifugation, as shown in the attached FIGS. 1a and 1b. In this case, the performance of nanofiltration is optional. The remaining liquid, e.g, the centrifuge overflow, can be subjected to the crossflow nanofiltration with a cut-off of 150-300 Da, preferably 180-220 Da. The nanofiltration retentate—comprising the desired low molecular weight proteins—or more simply—the centrifuge overflow from the starch/fiber separation, is washed with water—e.g. via ultrafiltration (hereinafter UF) of the nanofiltration retentate with plastic ultrafiltration membranes with a cut-off of 5-50 kDa, preferably 5-30 kDa and particularly preferably of 10 kDa or a pore size of 0.09-0.14 micrometer in the case of a ceramic membrane, with production of a protein-rich ultrafiltration retentate which is diafiltered to a reduction in conductivity of 20-80%, preferably 50-75% and particularly preferably 60-73%, and then further processed—optionally pasteurized and dried. Despite the cut-off specification of the membrane manufacturer, it must be checked whether the UF membrane is suitable for the desired proteins—not all UF membranes are suitable for the de facto separation of low molecular weight proteins despite the specification of an appropriate cut-off and allow salts, peptides, sugars and GOS to permeate. It may be useful to reduce phytate in the protein solution—e.g. by precipitation with divalent ions (calcium or similar) or adsorption on adsorbents such as resins or enzymatic degradation. The negative effects of phytate and the consequent separation of phytate in the context of the present invention is well known and was comprehensively explained at the International Phytate Conference in Bad Neuenahr on 29 Nov. 2017, to which full reference is made.

The UF retentate according to the invention can be processed directly as a solution in food mixtures, but can also be dried and then marketed as a powder. Particularly gentle drying processes, such as lyophilization, spray drying, film drying, fluid bed drying, etc., are suitable for this purpose.

The low-molecular-weight protein can be used as a substitute for milk, chicken egg white or cream, while its low fat content makes it more durable and storable at higher temperatures than these. It is non-gelling, which is advantageous for the preparation of liquids and allows protein fortification without thickening with less than 1 wt. % carbohydrates.

### Analytical Characterization

### Analytical Methods:

### Moisture Determination:

Device: Surface dryer (drying temperature 105° C. Step 2)

### Protein Content:

Nitrogen determination according to Kjeldahl (Nx6.25), DIN EN ISO 3188

### Product Solubility:

Weighing: 40 g demineralized H2 0+0.5 g product
Stirring time: 1 h
filling up to 50 mL in the volumetric flask
centrifuging at 2770 xg for 30 min
filtering through Whatmann filter (No. 1) (paper filter with 11 micrometer pore size)
weighing out 20-25 g of filtrate into a glass dish
drying in a drying oven at 100° C. for 24 hours

### Protein Solubility:

See product solubility
determining the nitrogen content of the filtrate according to Kjeldahl (Nx6.25), DIN EN ISO 3188
Weighing: approx. 6 g filtrate

### Ash:

Weighing: approx. 1 g product
Microwave oven: MAS 7000
Ashing temperature: 550° C.
Ashing time: 60 minutes

### Foam Activity and Stability:

dissolving 5 g product in 95 g demineralized H2 0
whipping for 15 minutes at Step 3 (Hobart 50-N)
determining foam volume=Foam activity in mL
determining foam volume after 60 min. standing time=Foam stability in %

### Emulsion Capacity:

Weighing: 80 g demin. H2 0+10 g product
pouring 250 ml_sunflower oil into a dropping funnel
stirring with Ultra Turrax at 20000 rpm, maintaining the temperature of 20° C.
adding sunflower oil continuously until phase inversion (until the emulsion becomes abruptly thinner)
determining the volume of unconsumed sunflower oil
250 ml_—Residual volume=Consumption (sunflower oil)
Result: 10 g product: 80 g demin. H2 0: Consumption/10
Viscosity measurement using Brookfield HAT, spindle 4, 20 rpm

The water-soluble protein produced in this way, with a molecular weight between <75 kDa and >5 kDa, is characterized by high foamability and foam stability as well as improved emulsification capacity compared to the previously available substitutes for milk proteins or poultry protein.

A nutritional analysis of the low molecular weight protein according to the invention showed (although the variations are inevitable in natural products):

### Chemical Test Results

Sample No: L2207754.003

Sample Designation: 17725 Soluble pea protein

| Parameter | | | |
|---|---|---|---|
| Result | Method | Unit | |
| Water | ASU L06.00-32014-08 mod. (a) | g/100 g | 6.8 |
| Protein | ASU L06.00-7 (Nx6.25) | g/100 g | 85.7 |
| | 2014-08 mod. (a) | | |
| Fat | ASU L06.00-62014-08 mod. (a) | g/100 g | 0.4 |
| Ash | ASU L06.00-42017-10 mod. (a) | g/100 g | 2.7 |
| Fatty acids | DGF C-Vl 10a 2010 mod. (a) | g/100 g | 0.3 |
| (saturated) | | | |
| Fatty acids | DGF C-Vl 10a 2010 mod. (a) | g/100 g | <0.2 |
| (mono- | | | |
| unsaturated) | | | |
| Fatty acids | DGF C-Vl 10a 2010 mod. (a) | g/100 g | <0.2 |
| (poly- | | | |
| unsaturated) | | | |
| Carbohydrates | Calculation from balance sheet(a) | g/100 g | <1.0 |
| Dietary fiber | ASU L00.00-18(#Fa) | g/100 g | 5.7 |
| Fructose | ASU L40.00-72019-07 mod. (a) | g/100 g | <0.4 |
| Glucose | ASU L40.00-72019-07 mod. (a) | g/100 g | <0.4 |
| Sucrose | ASU L40.00-72019-07 mod. (a) | g/100 g | <0.4 |
| Maltose | ASU L40.00-72019-07 mod. (a) | g/100 g | <0.4 |
| Lactose | ASU L40.00-72019-07 mod. (a) | g/100 g | <0.6 |
| Sugar | Calculation from HPLC(a) | g/100 g | <1.0 |
| Sodium | ASU L07.00-562000-07 mod. (a) | g/100 g | 0.367 |
| Table salt | Calculation from sodium(a) | g/100 g | 0.92 |
| Calorific value | Calculation(a) | kJ/100 g | 1517 |
| kJ | | | |
| Calorific value | Calculation (a) | kcal/100 g | 358 |
| kcal | | | |

Amino acid analysis:

Essential amino acids are underlined

| | | | Pea protein 10 |
|---|---|---|---|
| Amino acid | Pea protein | Pea protein | kDa with phytate |
| spectrum | 5 kDa | 10 kDa | precipitation |
| of pea | with phytate | with phytate | (mixed pattern of |
| proteins in % | precipitation | precipitation | different batches) |
| Lysine | 8.1 | 7.8 | 9.4 |
| Methionine | 0.5 | 0.5 | 0.9 |
| Cystine | | | 1.6 |
| Asparagine | 9.4 | 10.0 | 9.9 |
| Threonine | 4.2 | 4.1 | 5.4 |
| Serine | 3.6 | 3.7 | 3.9 |
| Glutamine | 17.0 | 16.0 | 15.8 |
| Proline | 3.0 | 2.9 | 3.2 |
| Glycine | 4.5 | 4.2 | 5.5 |
| Alanine | 5.4 | 4.9 | 6.2 |
| Valine | 3.4 | 3.3 | 3.5 |
| Isoleucine | 2.6 | 2.6 | 2.3 |
| Leucine | 3.3 | 3.6 | 2.8 |
| Thyrosine | 2.7 | 2.6 | 3.9 |
| Phenylalanine | 2.5 | 2.8 | 2.4 |
| Histidine | 2.7 | 2.4 | 2.8 |
| Arginine | 5.4 | 5.2 | 5.8 |
| Tryptophan | | | 0.5 |
| Total essential | 24.60 | 24.66 | 27.21 |
| amino acids | | | |

### PDCAAS

| | |
|---|---|
| Protein digestibility | 0.94 |
| Biological value of the protein | 0.47 |

Result+/−expanded measurement uncertainty (95%; k=2), sampling not included.

All %—information in this application refer to percent by weight. The E-numbers mentioned in the application correspond to the additives listed in Annex II, Part B LIST OF ALL ADDITIVES of Regulation (EC) No. 1333/2008 with their E-numbers for substances approved as the food additives in the EU. Among other things, they provide information on the type of the starch modification. Furthermore, it must always be taken into account that the natural fluctuations in the content of these plant parts are unavoidable due to weather, growing season and location.

In the following, the invention is explained by means of the exemplary embodiments as well as the drawings, to which it is by no means limited. Therein:

FIG. 1a shows a method diagram with a (optional) nanofiltration;

FIG. 1b shows a method diagram without a nanofiltration;

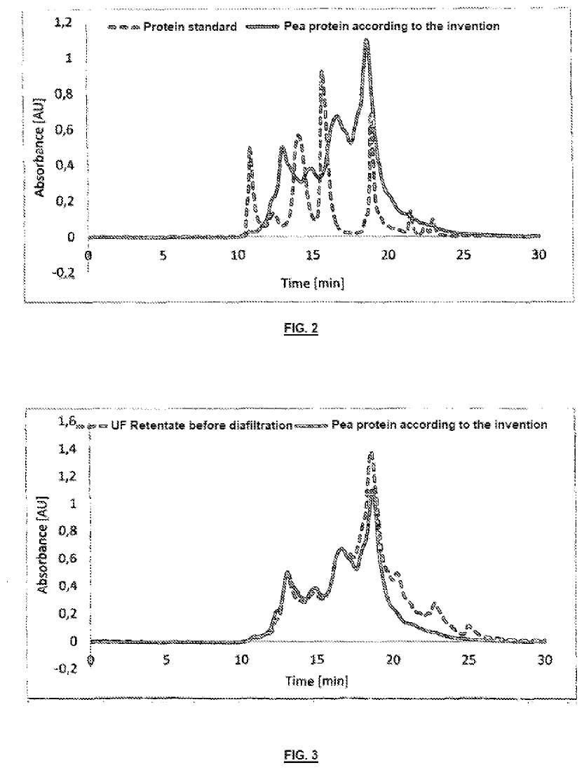

FIG. 2 shows HPLC chromatogram of low molecular weight pea protein and standard substances;

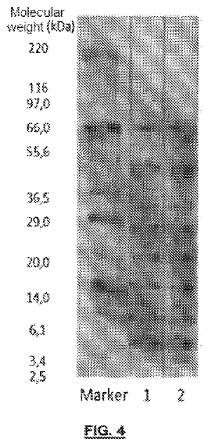

FIG. 3 shows HPLC chromatogram of low molecular weight pea protein diafiltered and without diafiltration; and

FIG. 4 shows SDS Page gel of two batches of pea protein according to the invention

### EXAMPLES OF THE PRODUCTION METHOD

### Example 1

To produce the water-soluble low molecular weight pea protein fraction, the dried peas were hulled, crushed and slurried in water and further processed as described in WO2008049385A1 and shown schematically in FIG. 1a. It can be seen that the first crushed peas are mixed with water, then subjected to the gravity separation (centrifugation) and the supernatant is further used as a protein-rich juice for the protein recovery. The thermal coagulation is carried out at the temperatures between 60 and 80° C., after which the resulting denatured proteins of larger molecular weight are separated by gravity separation. The denatured proteins remaining in the liquid phase, as well as phytate, are precipitated by the addition of CaCl2 and again separated by their gravity as the phytate sludge. The remaining protein-containing liquid was depleted of salts, sugars and GOS via nanofiltration and then ultrafiltrated and diafiltered with the demineralized water, wherein the ultrafiltration retentate was recovered as protein according to the invention while the peptides and amino acids remained in the filtrate (see FIG. 1a).

The low molecular weight pea protein fraction of high functionality obtained after separation of the medium molecular weight proteins with a reduction in conductivity of 20% by diafiltration with deionized water, pasteurization for 10 minutes at 80° C. and subsequent spray drying showed:

| | |
|---|---|
| Humidity, % | 6.2% |
| Protein content, % | 64.6 |
| Product solubility, % | 94.1 |
| Protein solubility, % | 91.3 |
| Ash, % | 6.5 |
| Foam activity, mL | 2200 (*after 15 min) |
| Foam stability, % | 100 |
| Emulsion capacity | >1:8:25 with 4280 |

The viscosity of the emulsion was measured at room temperature using Brookfield viscometer (DV1MHATJO) with a spindle 4 at 20 rpm.

The pea protein according to the invention does not form gels, but has a strong emulsifying effect.

### Example 2

The water-soluble low molecular weight pea protein fraction—prepared as in Example 1—was diafiltered with the demineralized water to a reduction in conductivity of 72% for 10 minutes at 67° C., pasteurized, and then spray dried. The spray-dried pea protein according to the invention showed the following data:

| | |
|---|---|
| Humidity, % | 4.9 |
| Protein content, % | 87.5 |
| Product solubility, % | 100 |
| Protein solubility, % | 100 |
| Ash, % | 2.2 |
| Foam activity, mL | 2800 (after 4 min) |
| Foam stability, % | 93 |
| Emulsion capacity | >1:8:25 with 5440 mPas |

### Example 3

To produce the water-soluble low molecular weight pea protein, the dried peas were hulled, crushed, slurried in water and further processed as described in Example 1. The supernatant of the gravity separation is further used as the protein-rich juice for the protein recovery. The phytates remaining in the liquid phase are precipitated by the addition of the precipitating agents, such as calcium chloride, and again separated by their gravity as the phytate sludge. The remaining protein-containing liquid was ultrafiltrated with a Sani-Pro MFK-618 membrane of Koch Membrane Solutions and diafiltered several times with tap water until the conductivity of the ultrafiltration residue was only 30% of the ultrafiltration feed. The peptides, amino acids, salts, sugars and GOS were washed out from the retentate and the protein according to the invention was recovered in the ultrafiltration retentate. The water-soluble low molecular weight pea protein fraction was diafiltered with the demineralized water to a reduction in conductivity of 67% for 10 minutes at 67° C., pasteurized, and then spray dried. The pea protein according to the invention showed the following data:

| | |
|---|---|
| Humidity, % | 6.9 |
| Protein content, % | 85.6 |
| Product solubility, % | 100 |
| Protein solubility, % | 100 |
| Ash, % | 2.9 |
| Foam activity, mL | 2600 (after 4 min) |
| Foam stability, % | 98 |

The method of Example 3 is shown in FIG. 1b. The effect of the longer diafiltration on the foam stability and ash content as well as the protein solubility in water compared to Example 1 can be clearly seen.

### Example 4

The low molecular weight water-soluble protein was analyzed using a HPLC from Knauer. As a column, a HPLC Xbridge BEH SEC 200A, 3.5 um from Waters, was used and eluted with an aqueous solution of 0.02 M Na2 HPO4/NaH2 P04 at pH 7. As the standards, the followings were used from Sigma-Aldrich:
670 kDa—Thyroglobulin
150 kDa—Gamma-Globulin
44.3 kDa—Ovalbumin
13.74 kDa—Ribonuclease A

UV absorption at 214 nm was used for the detection. The measured HPLC chromatogram is shown in FIG. 2. The standard proteins are shown as the relatively sharp peaks at 18.84 min for thyroglobulin; 14.12 min for gamma globulin; 15.74 min for ovalbumin; and 18.93 min for ribonuclease. The chromatogram of the protein according to the invention was compared with that of the standards. The different protein fractions can be clearly seen, wherein the small proteins predominate.

In FIG. 3, the influence of the diafiltration on the protein chromatogram was analyzed under the same conditions (same HPLC assembly). It can be clearly seen that the diafiltration removed the peaks in the range of 20-25 min.

An evaluation of the volume distribution showed that for both the protein standard and the pea protein according to the invention their relative peak ratios did not change even at different detector wavelengths. Therefore, a semi-quantitative statement about the volume distribution and a conclusion from the volume distribution to their molar masses is possible. The volume of the proteins in the pea protein according to the invention can therefore be assigned semi-quantitatively to the molecular weights:

The molar masses and retention times of the pea protein according to the invention:

| Max RT, | Start RT, min | End RT, min | Area, |
|---|---|---|---|
| min | (Molar mass, Da) | (Molar mass, Da) | % |
| 10.76 | 8.93 (1.650.000) | 11.00 (595.000) | 0.4 |
| 13.04 | 11.00 (595.000) | 14.24 (121.076) | 18.2 |
| 14.89 | 14.24 (121.076) | 15.45 (66.792) | 9.7 |
| 16.68 | 15.45 (66.792) | 17.58 (23.440) | 26.1 |
| 18.69 | 17.58 (23.440) | 29.97 (53) | 45.6 |

It is clearly evident that the low molecular weight proteins with a molecular mass between 0,053 and 23.5 kDa predominate in HPLC, followed by the proteins with a molecular mass between 23.5 and 66.8 kDa. The notable amounts of the protein are now only present with the molecular weights between 121.1 and 595 kDa.

The spray-dried low molecular weight protein according to Example 3 was dissolved in the elution buffer, then separated via HPLC and compared to the standard (high narrow peaks). Consequently, the volume of a protein of about 12 kDa is larger than the volumes of the proteins between about 20 and 150 kDa—essentially no proteins are found above 670 kDa. The effect of the diafiltration on the HPLC protein chromatogram was also analyzed (FIG. 3). The small peptides and other smaller molecules with the retention times longer than 20 min were found to be effectively separated by the diafiltration.

The low molecular weight protein according to the invention was also analyzed by SDS-gel chromatography—see FIG. 4. The selectivity of the method is clearly visible, which means that the larger proteins with a molecular weight >75 kDa are no longer present. Also, three most intense bands are seen in the range of about 15 kDa, about 40 kDa and about 66 kDa. Two methods are not comparable with respect to the averaged molecular weights, since the proteins are denatured differently in the measurement methods. Nevertheless, both methods show that three proteins are main components of the protein mixture.

Further application examples are given below, showing possible uses of the water-soluble protein according to the invention—further applications are obvious to the person skilled in the art.

In the area of the meat alternatives, the pea protein according to the invention, as described in Examples 2 and 3, achieves a meat-like texture without increasing viscosity, resulting in a spreadable mass that can be used for the protein fortification. In combination with the denatured pea globulin (the denatured protein of larger molecular weight obtained as an intermediate after heat coagulation in Example 1, with subsequent washout and spray drying), a firm texture can be obtained for e.g. a vegan sausage. In the areas of milk, milk alternative and other beverages, the high solubility, foaming and emulsifying properties for a pleasant mouthfeel are advantageous. In addition, no viscosity is formed even when heated and can thus be used for the protein enrichment here as well. Strong foaming is often desired in the baked goods and confectionery, for which the chicken egg white is usually used. The pea protein according to the invention can replace the chicken egg protein so that the vegan products can be produced. In all areas, however, the taste is of great advantage, since the denatured pea globulins, the medium molecular weight proteins according to DE 102006050619 B4 produced by EMSLAND STARKE as EMRPO E86, have a bitter pea taste and this is neutralized by the pea protein according to the invention.

### Example 5—Vegan Sausage

| Ingredients | Concentration [%] |
|---|---|
| Water | 63.0 |
| Pea protein Schnetzel | 12.0 |
| Denatured pea globulin EMPRO E86 | 6.0 |
| Pea protein according to the invention | 6.0 |
| (Example 2) | |
| Psyllium husks | 6.0 |
| Aroma, spices and coloring substances | 5.5 |
| Carrageenan | 1.0 |
| Brandy vinegar 5% | 0.5 |

12 g of pea protein mixture, 6 g of psyllium husk, 5.5 g of spices, flavoring and coloring substances and 1 g of the hydrocolloid were mixed and then kneaded with 63 g of water. To the mixture was added 12 g of crushed pea protein Schnetzel, mixed well and the mixture was stuffed into the sausage casings. The resulting vegan sausage was heated at 90° C. for 1 hour below 30% in a convection oven and then cooled. The pea protein of Example 2 according to the invention was used for the protein enrichment, texturing and taste enhancement, resulting in a shaped body of meat-like taste, texture and appearance.

The protein according to the invention neutralizes the bitter pea taste of the denatured pea globulin in the protein mixture, which is particularly undesirable in the meat and dairy product alternatives, and thus the sausage according to the invention stands out positively compared to the previous meat products.

### Example 6—Vegan Mince—Base Mass for Spreadable Product

| Ingredients | Concentration [%] |
|---|---|
| Water | 63.0 |
| Pea protein Schnetzel | 12.0 |
| Pea protein according to the invention | 8.0 |
| (Example 2) | |
| Psyllium husks | 6.0 |
| Aroma, spices and coloring substances | 5.5 |
| Denatured pea globulin EMPRO E86 | 2.0 |
| E1420—Potato starch | 2.0 |
| Carrageenan | 1.0 |
| Brandy vinegar 5% | 0.5 |

The vegan mince was prepared as in Example 5. The low-viscosity pea protein of Example 2 according to the invention made it possible to produce a spreadable mass as vegan mince with a meat-like taste. Compared with the denatured pea globulin, no viscosity or gelation forms during production using the pea protein according to the invention when heated at 90° C., which means that it remains spreadable, e.g. for a spread.

If necessary, the vegan fat particles can still be added to the vegan mince with a dosage of 10-20%. The vegan fat particles can be made from a combination of 57.7% water, 21.8% coconut fat (melting point 27° C.), 18.3% E1440—pea starch and 2.2% E1450—potato starch: Preparation in Thermomix®; counterclockwise knife, no butterfly mixer.
1. Mixing the dry ingredients
2. Water and fat were transferred to a heatable food processor called Thermomix®, the speed was set to ˜2.5 and heated to a maximum of 55° C.
3. After setting the speed to 4, the dry mixture was added slowly with stirring
4. The speed was set to 3.5 and the heat to 95° C.
5. After reaching the temperature of 80° C., setting to −5° C.
6. Holding the temperature for 5 minutes
7. Forming the product

### Example 7—Vegan Ice Cream

| Ingredients | Concentration [%] |
|---|---|
| Water | 38.3 |
| ALPRO ® Almond Drink | 35.0 |
| (2.3% almonds with emulsifier) | |
| Sugar | 8.0 |
| Denatured pea globulin EMPRO E86 | 5.0 |
| Pea protein according to the invention | 4.0 |
| (Example 2) | |
| Coconut fat (melting point (27° C.) | 4.0 |
| Glucose syrup (D.E. 40-44) | 3.0 |
| Cocoa powder | 1.9 |
| stabilizer mixture of emulsifier E471, | 0.5 |
| guar, locust bean gum, sodium | |
| alginate, carrageenan, potassium | |
| chloride, sodium tripolyphosphate | |
| Salt | 0.1 |
| Caramel taste | a.d. |

Mixing all dry ingredients
Pouring water into the Thermomix® TM6 stirring container
Adding the dry ingredients to the water while stirring (Step 4).
Slightly heating the glucose syrup in the microwave
Melting the coconut fat in saucepan
Mixing the coconut fat with the glucose syrup and adding while stirring (Step 4), then stirring for 1 minute.
Setting speed to 3.5; heating to 90° C. and holding the temperature for 10 minutes
Cooling in a water bath (at least 15° C.)
Adding flavorings
Storing overnight in the refrigerator
Processing into an ice cream with the ice cream maker (Telme—Gel 9 Gelatiera)

The result was a creamy vegan ice cream with a neutral taste.

### Example 8—Sliceable Vegan Imitation Cheese/Pizza Topping

| Ingredients | Concentration [%] |
|---|---|
| Water | 43.2 |
| Coconut fat (melting point 27° C.) | 19.4 |
| E1404—Potato starch | 19.3 |
| Denatured pea globulin EMPRO E86 | 7.8 |
| E1414—Potato starch | 5.0 |
| Pea protein according to the invention | 2.0 |
| (Example 2) | |
| E1450—Potato starch | 1.9 |
| Salt | 0.9 |
| Cheese aroma | 0.333 |
| Citric acid | 0.1 |
| ß-Carotene | 0.07 |

Mixing all dry ingredients
Transferring water and fat to a stove and heating to 50° C. in order to melt the fat
Adding cheese aroma and allow to dissolve in mixture 20
Adding the dry mixture and heating to 80-85° C., holding for 5 minutes
Pouring into the molds and cooling at 6-8° C.

The pea protein according to the invention neutralized the bitter taste of the denatured pea globulin and raised the protein content.

### Example 9—Ready-to-Shake Protein Drink

| Ingredients | Concentration [%] |
|---|---|
| Denatured pea globulin EMPRO E86 | 61.41 |
| Pea protein according to the invention | 33.06 |
| (Example 2) | |
| E1450—Potato starch | 1.9 |
| Cocoa powder | 2.70 |
| Cookie and Chocolate flavor | 2.00 |
| Citric acid | 0.50 |
| Acesulfame K | 0.15 |
| Aspartame | 0.10 |
| Xanthane | 0.08 |

Mixing the dry ingredients
Mixing 30 g of powder with 300 ml of ALPRO almond drink (2.3% almonds with emulsifier) or oat drink (8.7% oats without emulsifier)
Shaking for 30 seconds

Due to the highproduct solubility, the emulsifiability and low viscosity, the pea protein according to the invention was used to produce a ready-to-shake protein drink with a very smooth mouthfeel and foamy texture compared to the drink produced with the denatured pea globulin only.

### Example 10—Clean Label Salad Cream 50% Oil

| Ingredients | Concentration [%] |
|---|---|
| Sunflower oil | 50.0 |
| Water | 35.5 |
| Cold water soluble potato starch | 5.0 |
| Brandy vinegar 10% | 3.0 |
| Sugar | 3.0 |
| Mustard | 1.5 |
| Pea protein according to the invention | 1.0 |
| (Example 2) | |
| Salt | 1.0 |

Mixing protein and starch
Mixing vinegar and mustard
Mixing water with sugar and salt
Dispersing the protein-starch mixture in twice the amount of oil, 1 min, 3000 rpm
Slowly adding the remaining oil and dispersing, 3000 rpm
Adding all other components
Emulsifying, 3000 rpm, 1 to 2 minutes

The result was a viscous sauce with a very fine distribution of the fat droplets and high stability of the emulsion produced in this way.

### Example 11—Egg White Substitute in Vegan Meringue

With a small amount of protein used, strong but very fine foaming and a high shine were achieved in the baked goods. For this purpose, a 1.5% solution was prepared from the low molecular weight plant protein according to the invention, as described in Example 2. 39.9% of the protein solution produced in this way—which corresponds to 0.6% plant protein—was whipped with 59.9% sugar and 0.20% xanthane. The result was an egg white-like foam that could be baked in the oven for 1 hour at 100° C. or for 4 hours at 80° C.—to make airy vegan meringues.

### Example 12—Vegan Marshmallows

Animal protein has been used to make marshmallows for decades. The vegan marshmallows can be produced due to the strong foaming of the pea protein according to the invention. To do this, 2 g of the low molecular weight plant protein according to the invention from Example 2 are dissolved in 3 g of water and left to stand at 50° C. for 30 minutes. A suspension was prepared from 43.5 g sugar, 42 g glucose syrup (D.E. 40-44), 2.5 g 75% pea starch E1440 and 25% waxy potato starch E1442, 7 g water. This suspension was boiled down to a dry matter content of 88%. After cooking, the pea protein according to the invention according to Example 2 was added with stirring. This mixture was then whipped and extruded.

Instead of mixing the protein solution and the cooked suspension, both solutions can be combined in a mixing head of a drawing machine and subsequently aerated/whipped therein.

The marshmallows had an elastic texture and could be chewed like the foam products made with the animal eggs and gelatin.

Although the invention is described with reference to the exemplary embodiments, these exemplary embodiments are by no means intended to describe all possible forms of the invention. Instead, the words used in the description are descriptive rather than restrictive in nature and, of course, the equivalent modifications familiar to those skilled in the art are included without departing from the spirit and scope of the invention. Further, the features of various exemplary embodiments may be combined to form further exemplary embodiments of the invention.

1. A low molecular weight water-soluble plant protein having a molecular weight (according to SDS-page primary structure) of <75 kDa and >5 kDa, prepared from the protein-containing plant parts, characterized by:
a) Protein content of 60-95 wt. %
b) Moisture content of 4-8%
c) Foam volume of 1700-3100 ml
d) Foam stability of 80-100%
e) Product solubility of 100% (pH 7-pH 9)

2. A method for producing a protein according to claim 1, characterized in that it is a low molecular weight pea protein fraction obtainable by:
a) preparing a pea pulp from peas and water, mechanically separating the pea pulp into the insoluble starch and fibers, and an aqueous solution containing the water-soluble proteins, peptides, sugars, salts, and amino acids (pea fruit water);
b) thermally coagulating the pea fruit water at 64-70° C. followed by the mechanical separation of the coagulated denatured pea proteins with a molecular weight >75 kDa;
c) carrying out a phytate reduction by the precipitation of the phytate compounds, adsorption on phytate adsorbers or enzymatic degradation;
d) centrifuging or filtrating to separate the precipitated phytates to obtain a phytate-reduced water-soluble low-molecular-weight protein fraction;
e) optionally carrying out a nanofiltration process of the centrifuge supernatant with a membrane of a cut-off of 150-300 Da, to obtain a protein-rich nanofiltration retentate and a salt-containing permeate;
f) carrying out an ultrafiltration process of the nanofiltration retentate using plastic ultrafiltration membranes with a cut-off of 5-50 kDa or a pore size of 0.09-0.14 micrometer in the case of a ceramic membrane, producing a more protein-rich ultrafiltration retentate;
g) carrying out a diafiltration process on the ultrafiltration retentate using water;
h) optionally pasteurizing the ultrafiltration retentate and
i) optionally drying the ultrafiltration retentate

3. The method according to claim 2, characterized in that the ultrafiltration retentate is washed by diafiltration with tap water, service or process water or deionized water until the conductivity of the retentate solution is reduced by 20-80%.

4. The method according to claim 2, characterized in that it is pasteurized between 65 and 100° C. for a holding time between 1-10 min.

5. A protein according to claim 1, characterized in that the starch-containing plant parts are selected from the root and tuber plants; legume seeds selected from the beans, peas, chickpeas, lentils, soybeans; tree fruits; perennials and herbaceous fruits; sweet grasses and their fruits, and algae.

6. The protein according to claim 1, characterized in that it is a component of a food or food additive, a dietary food or food additive for human or animal consumption.

7. The low molecular weight water-soluble plant protein according to claim 1, wherein the molecular weight is <70 kDa and >7 kDa.

8. The low molecular weight water-soluble plant protein according to claim 1, wherein the molecular weight is <68 kDa and >10 kDa.

9. The method according to claim 2, wherein the washing by diafiltration with tap water, service or process water or deionized water is performed until the conductivity of the retentate solution is reduced by 50-75%.

10. The method according to claim 2, wherein the washing by diafiltration with tap water, service or process water or deionized water is performed until the conductivity of the retentate solution is reduced by 60-73%.
